(19) United States
(12) Patent Application Publication
(10) Pub. No.: US 2023/0305458 A1
(43) Pub. Date: Sep. 28, 2023

(54) FIXING DEVICE AND IMAGE FORMING APPARATUS

(71) Applicant: FUJIFILM Business Innovation Corp., Tokyo (JP)

(72) Inventors: Takashi MATSUBARA, Kanagawa (JP); Takashi OHASHI, Kanagawa (JP); Takuma ISHIHARA, Kanagawa (JP)

(73) Assignee: FUJIFILM Business Innovation Corp., Tokyo (JP)

(21) Appl. No.: 17/882,597

(22) Filed: Aug. 7, 2022

(30) Foreign Application Priority Data
Mar. 23, 2022 (JP) 2022-047448

(51) Int. Cl. G03G 15/20

(52) U.S. Cl. CPC G03G 15/2053; G03G 15/2025; G03G 15/206

(57) ABSTRACT

A fixing device includes an endless belt-shaped section; a heating section that supports and rotates the belt-shaped section and generates heat during energization to heat the belt-shaped section; and a terminal portion that is provided at an end part of the heating section and feeds power to the heating section. An outer diameter of the terminal portion is equal to or smaller than an outer diameter of the heating section.

### CROSS-REFERENCE TO RELATED APPLICATIONS

This application is based on and claims priority under 35 USC 119 from Japanese Patent Application No. 2022-047448 filed Mar. 23, 2022.

### BACKGROUND

### (i) Technical Field

The present invention relates to a fixing device and an image forming apparatus.

### (ii) Related Art

In image forming apparatuses, techniques described in JP1997-120223A, JP1998-3226A, and JP2017-10020A are known with respect to a fixing device that fixes an unfixed developer transferred to ta medium.

JP1997-120223A as Patent Document 1 describes a configuration in which, in a heating roller (1) in which a core roller (10), an electrically insulating layer (15), a resistance heat generation layer (13), and a release layer (14) are laminated, both end parts of the resistance heat generation layer (13) in a roller axial direction are longer than the release layer (14) and are exposed, and ring-shaped power receiving members (11a, 11b) are mounted on the exposed portions, and power is fed from power feed members (12a, 12b) to the power receiving members (11a, 11b).

JP1998-3226A as Patent Document 2 describes a heating roller (10) in which an insulating film material (14) made of polyimide resin is disposed on an inner surface of the roller body (11), and a heating element (15) is further inside the insulating film material (14). In the configuration of JP1998-3226A, power is fed to the heating element (15) from brushes (17, 19) at the tips of sliding electrode (16, 18) disposed so as to be inserted inside the roller body (11) from the axial direction.

JP2017-10020A as Patent Document 3 describes a configuration in which conductive layers (1b) are provided at both end parts of a heat generation layer (1a) of a tubular fixing film (1), power is fed to the conductive layer (1b) from power feed members (3a, 3b) disposed inside a cylinder so as to be inserted from the axial direction, and the heat generation layer (1a) generates heat.

### SUMMARY

Aspects of non-limiting embodiments of the present disclosure relate to a fixing device and an image forming apparatus that facilitate the attachment and detachment of a belt-shaped section as compared to a case where the outer diameter of a terminal portion is larger than the outer diameter of a heating section in a configuration in which the terminal portion is provided in the heating section that supports and rotates the belt-shaped section and heats the belt-shaped section.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including: an endless belt-shaped section; a heating section that supports and rotates the belt-shaped section and generates heat during energization to heat the belt-shaped section; and a terminal portion that is provided at an end part of the heating section and feeds power to the heating section, in which an outer diameter of the terminal portion is equal to or smaller than an outer diameter of the heating section.

### BRIEF DESCRIPTION OF THE DRAWINGS

Exemplary embodiment(s) of the present invention will be described in detail based on the following figures, wherein:

FIG. 1 is an overall explanatory view of an image forming apparatus according to Example 1 of the present invention;

FIG. 2 is a schematic explanatory view of a heat generation roll of Example 1;

FIG. 3 is a cross-sectional view of major parts of the heat generation roll of Example 1;

FIGS. 4A and 4B are explanatory views of the operation of Example 1, FIG. 4A is an explanatory view of a related-art configuration, and FIG. 4B is an explanatory view of the configuration of Example 1;

FIG. 5 is an explanatory view of a heat generation roll of Example 2, and is a view corresponding to FIG. 2 of Example 1; and

FIG. 6 is an explanatory view of a fixing device of Example 3.

### DETAILED DESCRIPTION

Next, examples as specific examples of an exemplary embodiment of the present invention will be described with reference to drawings, but the present invention is not limited to the following Examples.

In addition, in order to facilitate the understanding of the following explanations, in the drawings, a front-back direction is referred to as an X-axis direction, a left-right direction is referred to as a Y-axis direction, and an up-down direction is referred to as a Z-axis direction, directions or sides indicated by arrows X, −X, Y, −Y, Z, and −Z are respectively a front, back, right, left, up, and down, or front side, back side, right side, left side, upper side, and lower side.

Additionally, in the drawings, one in which “.” is described in “O” means an arrow directed from the back to the front of the paper, and one in which “X” is described in “O” means an arrow directed from the front to the back of the paper.

In addition, in the explanation using the following drawings, illustrations other than members necessary for the explanation are omitted appropriately for the sake of easy understanding.

### Example 1

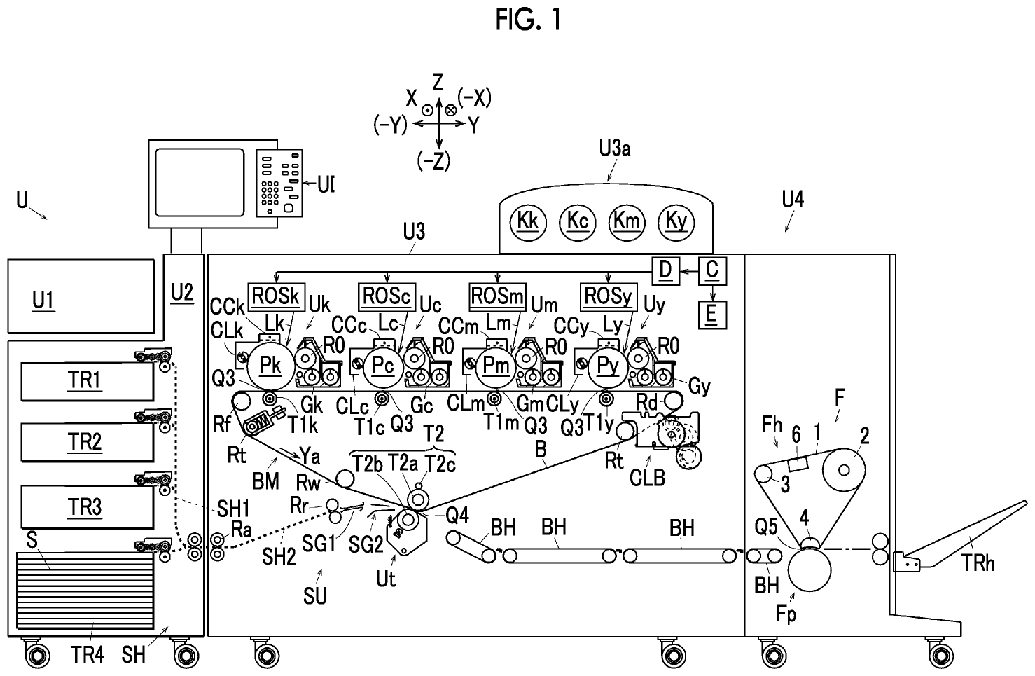

FIG. 1 is an overall explanatory view of an image forming apparatus according to Example 1 of the present invention.

In FIG. 1, a copying machine U as an example of the image forming apparatus includes an operating part UI, a scanner device U1 as an example of an image reading device, a paper feed device U2, a printer part U3 as an example of an image recording device, and a paper ejection part U4.

The operating part UI has a power button, a copy start key, a copy number setting key, numeric keypads, and the like, as examples of an input part, a display part, and the like.

The scanner device U1 reads an original document (not shown), converts the read data into image information, and inputs the converted information to the printer part U3.

The paper feed device U2 has a plurality of paper feed trays TR1 to TR4 as an example of the paper feed part. Recording paper S as an example of the medium is accommodated in each of the paper feed trays TR1 to TR4. A paper feed route SH1 as an example of a medium transport route extends from the paper feed trays TR1 to TR4 toward the printer part U3.

In FIG. 1, the printer part U3 has a control part C, a power source circuit E controlled by the control part C to supply power to each member of the printer part U3, and the like. The control part C receives the image information of the original document read by the scanner device U1 and image information transmitted from a personal computer as an example of an information transmission device (not shown) connected to the copying machine U.

The control part C processes the received image information into Y: yellow, M: magenta, C: cyan, and K: black printing information, and outputs the processed information to a laser drive circuit D as an example of a drive circuit of a latent image writing device. The laser drive circuit D outputs a laser drive signal input from the control part C to exposure devices ROSy, ROSm, ROSc, and ROSk as examples of a latent image forming section for each color at a preset timing.

Image holder units Uy, Um, Uc, and Uk of Y, M, C, and K are disposed below the respective exposure device ROSy to ROSk.

In FIG. 1, the K: black image holder unit Uk has a photoconductor drum Pk as an example of an image holding section, a charging corotron CCk as an example of a charging section, and a photoconductor cleaner CLk as an example of a cleaning section for the image holding section. Also, the image holder units Uy, Um, and Uc of the other colors Y, M, and C also have photoconductor drums Py, Pm, and Pc, charging corotrons CCy, CCm, and CCc, and photoconductor cleaners CLy, CLm, and CLc.

In addition, in Example 1, the K-color photoconductor drum Pk, which has a high frequency of use and has a large surface wear, is configured to have a larger diameter than the photoconductor drums Py, Pm, and Pc of other colors, and is compatible with high-speed rotation and has a long service life.

The photoconductor drums Py, Pm, Pc, and Pk are uniformly charged by the charging corotrons CCy, CCm, CCc, and CCk, respectively, and then electrostatic latent images are formed on the surfaces of the photoconductor drums Py to Pk by laser beams Ly, Lm, Lc, and Lk as examples of latent image writing light output by the exposure devices ROSy to ROSk. The electrostatic latent images on the surfaces of the photoconductor drums Py to Pk are developed into toner images of respective colors of Y: yellow, M: magenta, C: cyan, and K: black by developing rolls R0 examples of developing members provided in the developing devices Gy, Gm, Gc, Gk as examples of a developing section.

The toner images on the surfaces of the photoconductor drums Py to Pk are sequentially and overlappingly transferred to an intermediate transfer belt B as examples of an intermediate transfer section and examples of the image holding section, in a primary transfer region Q3 by primary transfer rolls T1y, T1m, T1c, and T1k as examples of a primary transfer section, and a multicolor image, a so-called color image, is formed on the intermediate transfer belt B. The color image formed on the intermediate transfer belt B is transported to a secondary transfer region Q4.

In addition, in the case of only black image data, only the K: black photoconductor drum Pk and the developing device Gk are used, and only a black toner image is formed.

After the primary transfer, residual toners remaining on the surfaces of the photoconductor drums Py to Pk are cleaned by the photoconductor cleaners CLy, CLm, CLc, and CLk.

Toner image forming members Uy+Gy, Um+Gm, Uc+Gc, and Uk+Gk as examples of a visible image forming unit is constituted by the respective image holder units Uy to Uk and the developing devices Gy to Gk.

A toner dispenser U3a as an example of a replenishment section is disposed on an upper portion of the printer part U3, and toner cartridges Ky, Km, Kc, and Kk as examples of a developer accommodation section are attachably and detachably mounted on the toner dispenser U3a. In a case where the toner is consumed in the developing devices Gy to Gk with the image formation, the toner is supplied from each of the toner cartridges Ky to Kk to each of the developing devices Gy to Gk.

The intermediate transfer belt B disposed below the photoconductor drums Py to Pk is stretched by an intermediate drive roll Rd as an example of a drive section of an intermediate transfer section, an intermediate tension roll Rt an example of a tension application unit that applies tension to the intermediate transfer belt B, an intermediate steering roll Rw as an example of a first bias correction section that corrects bias or meandering of the intermediate transfer belt B, and a plurality of intermediate idler rolls Rf as examples of a driven section, and a backup roll T2a as an example of a facing section of the secondary transfer region. Also, the intermediate transfer belt B is supported so as to be rotatable and movable in a direction of arrow Ya by being driven by the intermediate drive roll Rd.

A belt module BM as an example of the intermediate transfer device is constituted by the intermediate drive roll Rd, the intermediate tension roll Rt, the intermediate steering roll Rw, the intermediate idler roll Rf, the backup roll T2a, the primary transfer rolls T1y to T1k, the intermediate transfer belt B, and like. In addition, the belt module BM of Example 1 is configured by a unit that is attachable and detachable or replaceable with respect to the printer part U3.

A secondary transfer unit Ut as an example of a transfer and transport section is disposed below the backup roll T2a. The secondary transfer unit Ut has a secondary transfer roll T2b as an example of a transfer member. The secondary transfer roll T2b is disposed so as to face the backup roll T2a. The secondary transfer region Q4 is constituted by a region where the secondary transfer roll T2b faces the intermediate transfer belt B. Additionally, the backup roll T2a is in contact with a contact roll T2c as an example of a contact section that applies a voltage. A secondary transfer voltage having the same polarity as the charging polarity of the toner is applied to the contact roll T2c at a preset timing from the power source circuit E controlled by the control part C.

A secondary transfer device T2 as an example of a secondary transfer section is constituted by each of the rolls T2a to T2c. Additionally, a transfer device B+T1+T2 as an example of a transfer section is constituted by the intermediate transfer belt B, the primary transfer rolls T1y to T1k, the secondary transfer device T2, and the like.

A paper transport route SH2 is disposed below the belt module BM. The recording paper S fed from the paper feed route SH1 of the paper feed device U2 is transported to the paper transport route SH2 by the transport roll Ra as an example of a transport section. The recording paper S of the paper transport route SH2 is fed by a registration roll Rr as an example of a delivery section at the timing when the toner image is transported to the secondary transfer region Q4, and is guided by paper guides SG1 and SG2 as examples of a medium guide unit and transported to the secondary transfer region Q4.

The toner image on the intermediate transfer belt B is transferred to the recording paper S by the secondary transfer device T2 in a case where the toner image passes through the secondary transfer region Q4. In addition, in the case of a color image, the toner images that are overlapped on the surface of the intermediate transfer belt B and are primarily transferred are collectively and secondarily transferred to the recording paper S.

The intermediate transfer belt B after the secondary transfer is cleaned by a belt cleaner CLB as an example of the cleaning section of the intermediate transfer section.

The recording paper S to which the toner image is secondarily transferred is sent to the medium transport belt BH as an example of the transport section. The medium transport belt BH transports the recording paper S to a fixing device F. The fixing device F as an example of a fixing section has a heating unit Fh as an example of a heating part and a pressure roll Fp as an example of a pressure section, and a fixing region Q5 is formed by the contacting region is formed by a region where the heating unit Fh and the pressure roll Fp face each other.

In a case where the toner image on the recording paper S passes through the fixing region Q5, the toner image is heated and fixed by the fixing device F. The recording paper S on which the toner image is fixed by the fixing device F is ejected to an ejection tray TRh as an example of an ejection part.

The paper transport route SH is constituted by the reference numerals SH1, SH2, and the like. Additionally, the paper transport device SU is constituted by the reference numerals SH, Ra, Rr, SG1, SG2, BH, and the like.

### Explanation of Fixing Device

In FIG. 1, the heating unit Fh of the fixing device F of Example 1 has an endless fixing belt 1 as an example of a belt-shaped section. The fixing belt 1 of Example 1 is an example of a heating section, and is supported by a heat generation roll 2 as an example of a heat generation member, a drive roll 3 as an example of a drive section, and a fixing pad 4 as an example of a facing section. The heat generation roll 2 generates heat during the image forming operation to heat the fixing belt 1. The drive roll 3 rotates the fixing belt 1 during the image formation. The fixing pad 4 makes the fixing belt 1 face the pressure roll Fp in the fixing region Q5. Additionally, a lubrication wick 6 is disposed as an example of a lubrication section and as an example of a supply section on an inner surface side of the fixing belt 1. The lubrication wick 6 supplies silicon oil as an example of a lubricating material for lubricating the fixing belt 1 and the fixing pad 4 to the inner surface of the fixing belt 1.

### Explanation of Heat Generation Roll

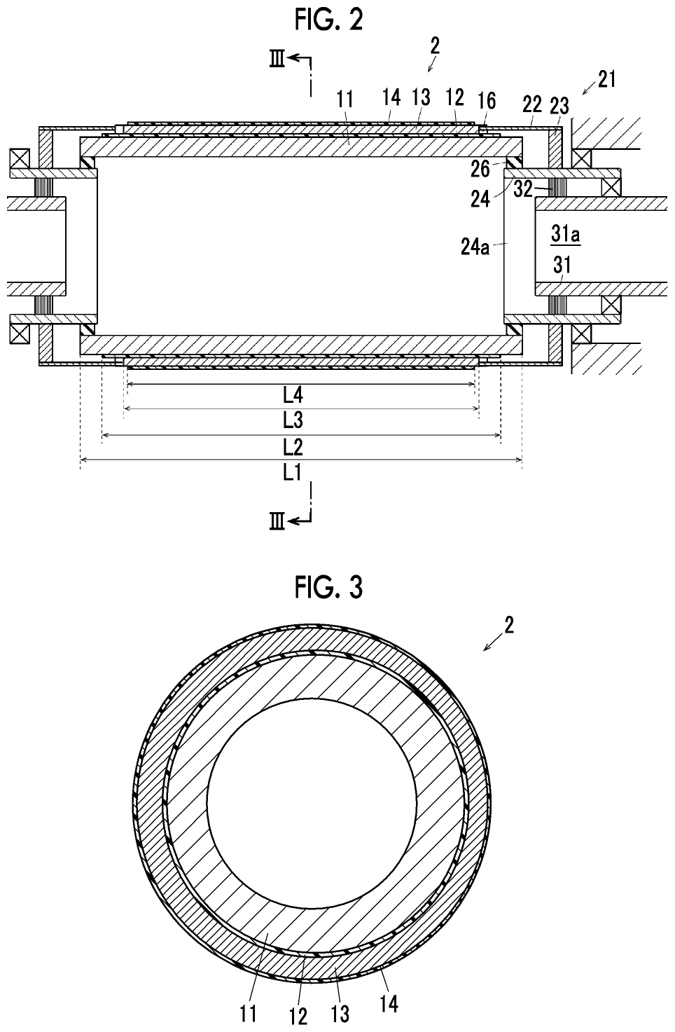

FIG. 2 is a schematic explanatory view of the heat generation roll of Example 1.

FIG. 3 is a cross-sectional view of major parts of the heat generation roll of Example 1.

In FIGS. 2 and 3, the heat generation roll 2 of Example 1 has a core metal 11 as an example of a base layer. The core metal 11 of Example 1 is made of a conductive metal material. As an example, it is preferable that the core metal 11 is made of, for example, aluminum, but it is also possible to use a conductive alloy such as iron or stainless steel. Additionally, the core metal 11 of Example 1 is formed in a cylindrical shape that extends in a rotation axis direction.

An insulating layer 12 as an example of an insulating portion is formed on an outer periphery of the core metal 11. The insulating layer 12 of Example 1 is made of an electrically insulating material, and as an example, a polyimide resin, a glass resin, a PEEK resin, a fluororesin, a polyamide resin, a polyimideamide resin, and a PEKK (polyetherketoneketone) resin, or the like can be used.

A heat generation layer 13 as an example of a heat generation portion is formed on an outer surface side of the insulating layer 12. The heat generation layer 13 is configured by a resistance heating element that generates heat during energization. In addition, since the resistance heating element itself is described in, for example, JP1998-3226A and JP2017-10020A and is known in the related art, detailed description thereof will be omitted.

A surface layer 14 as an example of an outer layer and an example of the insulating layer is formed on an outer surface side of the heat generation layer 13. It is desirable that the surface layer 14 of Example 1 is made of, for example, an electrically insulating material. In a case where the surface layer 14 is made of a conductive material, there are problems that current easily flows from the heat generation layer 13, there is a need to increase the power capacity of the power source circuit E and a leak to the fixing belt 1 occurs. Thus, it is desirable that the surface layer 14 of Example 1 is made of, for example, the electrically insulating material. As the electrically insulating material, for example, a polyimide resin, a glass resin, a PEEK resin, a fluororesin, a polyamide resin, a polyimideamide resin, a PEKK (polyetherketoneketone) resin, or the like can be used. Additionally, it is desirable that the surface layer 14 of Example 1 is made of a wear-resistant material, for example, in response to contact or wear with the fixing belt 1. Examples of a material having electrical insulation and wear resistance include polyimide resin, glass resin, PEEK resin, and fluororesin.

Moreover, it is desirable that the surface layer 14 of Example 1, for example, has a lower (heat resistance)=(thermal conductivity)×(thickness) than the insulating layer 12 from the viewpoint of the transfer efficiency of heat to the fixing belt 1. That is, out of the insulating layer 12 and the surface layer 14 sandwiching the heat generation layer 13, the smaller the heat resistance, the easier the heat is transferred. Therefore, for example, it is desirable that the heat resistance of the surface layer 14 on the fixing belt 1 side is smaller. Thus, in a case where the surface layer 14 is made of the same PEEK resin as the insulating layer 12, for example, it is preferable that the heat resistance can be lowered by making the thickness of the surface layer 14 smaller than the thickness of the insulating layer 12.

In FIG. 2, in the heat generation roll 2 of Example 1, the length thereof in the rotation axis direction is the longest in a length L1 of the core metal 11, a length L2 of the insulating layer 12, a length L3 of the heat generation layer 13, and the length L4 of the surface layer 14 are set to L1>L2>L3 L4.

Silver paste 16 for feeding power is applied to both end parts of the heat generation layer 13 in the axial direction.

Terminal portions 21 to which power is fed are disposed as an example of electrodes at both the end parts of the heat generation roll 2 in the axial direction.

Each terminal portion 21 has a contact ring 22 as an example of a contact portion. The contact ring 22 is configured in a ring shape. An inner end part of the contact ring 22 is in contact with the silver paste 16. The outer diameter of the contact ring 22 of Example 1 is formed to be equal to or smaller than the diameter of the surface layer 14. That is, the outer diameter of the terminal portion 21 is configured to have a size equal to or smaller than the outer diameter of the surface layer 14, that is, the outer diameter of the heat generation roll 2. In Example 1, the outer diameter of the terminal portion 21 is set to be smaller than the outer diameter of the heat generation roll 2.

A radially outer end of a connection flange 23 as an example of a connecting part is connected to a radially inner peripheral surface of an outer end part of the contact ring 22. A radially inner end of the connection flange 23 extends radially inward from a radially inner surface of the core metal 11.

A power-fed ring 24 as an example of a power-fed portion is disposed at a radially inner end part of the connection flange 23. The power-fed ring 24 is supported on the core metal 11 by a fixing portion 26 inside the heat generation roll 2 in the axial direction. The power-fed ring 24 of Example 1 is formed with a through-hole 24a through which a member can pass in the axial direction on the inner side in the radial direction. In Example 1, the power-fed ring 24, the connection flange 23, and the contact ring 22 are supported to be rotatable integrally with the core metal 11 via the fixing portion 26.

The terminal portion 21 of Example 1 is constituted by respective parts designated by reference numerals 22 to 26.

In addition, in Example 1, the contact ring 22, the connection flange 23, and the power-fed ring 24 are made of a conductive material, and the fixing portion 26 is made of an electrically insulating material.

A power feed shaft 31 as an example of a power feed section is disposed at the through-hole 24a of the power-fed ring 24 in the radial direction of the heat generation roll 2. The power feed shaft 31 of Example 1 is formed in a tubular shape, and a through-hole 31a through which a member can pass in the axial direction is formed inside the power feed shaft 31.

A power feed brush 32 is disposed on an outer periphery of the power feed shaft 31. The power feed brush 32 is in contact with the power-fed ring 24. The power feed shaft 31 is connected to a power source circuit (not shown). Therefore, power for heat generation is supplied to the heat generation layer 13 via the power feed shaft 31, the power feed brush 32, and the terminal portion 21.

### Action of Example 1

In the copying machine U of Example 1 including the above configuration, in a case where the image forming operation is started, the heat generation layer 13 is energized, the heat generation layer 13 generates heat, and the heat generation roll 2 heats the fixing belt 1 to raise the temperature of the fixing region Q5 to a predetermined fixing temperature. Then, the recording paper S passing through the fixing region Q5 is heated to fix the toner.

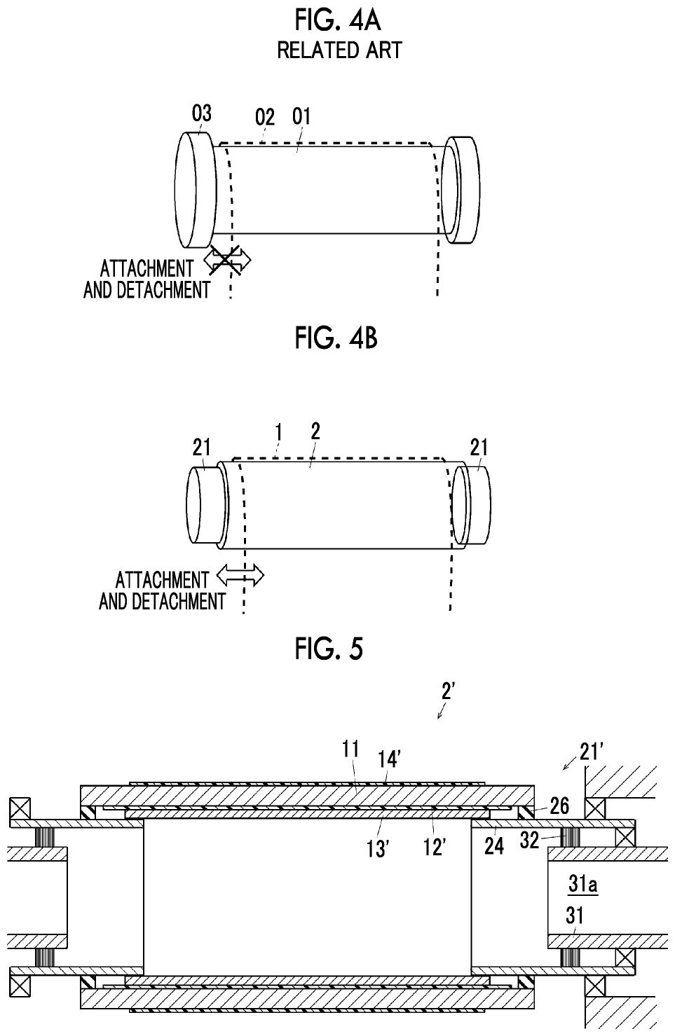

FIGS. 4A and 4B are explanatory views of the operation of Example 1, FIG. 4A is an explanatory view of a related-art configuration, and FIG. 4B is an explanatory view of the configuration of Example 1.

In FIG. 4A, in a configuration in which the fixing belt 02 is stretched on the heat generation roll 01 as shown in JP1997-120223A, JP1998-3226A, and JP2017-10020A in the related-art heat generation roll 01, there are many configurations in which power is fed from the outer side in the radial direction as described in JP1997-120223A. Even in a configuration in which power is fed from the inner side in the radial direction as in JP1998-3226A and JP2017-10020A, the bearing 03 for rotatably supporting the heat generation roll 01 is provided on the outer peripheral side of the heat generation roll 01. Therefore, in the related-art configuration as described in JP1997-120223A, JP1998-3226A, and JP2017-10020A, the outer diameter of the axial end part (03) of the heat generation roll 01 is larger than the outer diameter of the heat generation roll 01.

Here, the fixing belt 02 is stretched on the heat generation roll 01, and the fixing belt 02 may be attached to or detached from the heat generation roll 01 by replacing or inspecting components. In a configuration where the fixing belt 02 cannot be attached and detached, there are problems that the fixing belt 02, the heat generation roll 01, the drive roll, the fixing pad, and the like are all be replaced integrally, and even the components that do not need to be replaced are replaced, and the cost of replacement components becomes high.

In order to attach and detach the fixing belt 02 with respect to the heat generation roll 01, it is necessary to loosen the fixing belt 02 on which tension is applied and pull out (relatively move) the fixing belt 02 in the axial direction of the heat generation roll 01. However, in a case where the outer diameter of the axial end part of the heat generation roll 01 is large, it is necessary to loosen the fixing belt 02 greatly so that the end part (03) having a large outer diameter and the fixing belt 02 do not interfere with each other. Therefore, it is necessary to greatly move the heat generation roll 01 and the drive roll, which stretch the fixing belt 02, to loosen the fixing belt greatly. In order to move the heat generation roll 01 greatly, it is necessary to secure a space for the heat generation roll 01. Therefore, there is a problem that the size of the fixing device F is increased by the space to be secured.

In contrast, in Example 1, the outer diameter of the terminal portions 21 at both end parts is set to be smaller than the outer diameter of the heat generation roll 2. Therefore, as compared to a case where the outer diameter of the end part 03 is larger than the outer diameter of the heat generation roll 01, the fixing belt 1 may be easily attached and detached without moving the heat generation roll 2 greatly. Therefore, the size of the fixing device F can be reduced. Additionally, as compared to a case where the fixing belt 1 is not attachable and detachable, it is possible to suppress the replacement of the components that do not need to be replaced and the cost of the replaced components.

Additionally, in the fixing device F of Example 1, the fixing pad 4 is disposed corresponding to the fixing region Q5. The fixing pad 4 is disposed in a non-rotating state with respect to the fixing belt 1, and the shape, posture, and state of the fixing region Q5 are likely to be stable. Thus, fixing is likely to be stable.

Then, in Example 1, the lubricating material for lubricating the fixing pad 4 and the fixing belt 1 is supplied to an inner surface of the fixing belt 1. In the related-art configuration in which the end part 03 has a larger diameter, in a case where the fixing belt 02 is replaced, the lubricating material adhering to the inner surface of the fixing belt 02 may easily come into contact with the end part 03, the end part 03 may be easily soiled by the lubricating material, and poor energization may occur due to the adhered lubricating material. In contrast, in Example 1, compared to a case where the terminal portion 21 has a smaller diameter than the heat generation roll 2 and the end part 03 has a larger diameter, the inner surface of the fixing belt 1 and the terminal portion 21 do not easily come into contact with each other in a case where the fixing belt 1 is attached or detached. Therefore, soiling on the terminal portion 21 is suppressed.

Moreover, in Example 1, the through-holes 24a and 31a through which the member can pass in the axial direction are formed in the terminal portion 21 and the power feed shaft 31. Although not provided in Example 1, a heat source such as a halogen lamp for supplementing the amount of heat can be added and optionally installed so as to penetrate the heat generation roll 2. Therefore, it is possible to increase the variation of the device configuration as compared to a case where the through-holes 24a and 31a are not provided.

### Example 2

Next, Example 2 of the present invention will be described. In the description of Example 2, the constituent elements corresponding to the constituent elements of Example 1 are designated by the same reference numerals, and detailed description thereof will be omitted.

Example 2 is different from the above-mentioned Example 1 in the following points, but is configured similar to the above-mentioned Example 1 in other points.

FIG. 5 is an explanatory view of a heat generation roll of Example 2, and is a view corresponding to FIG. 2 of Example 1.

In FIG. 5, in a heat generation roll 2′ of Example 2, unlike the heat generation roll 2 of Example 1, an insulating layer 12′ is disposed on a radially inner surface side of the core metal 11, and the heat generation layer 13′ is disposed on a further radially inner surface side of the insulating layer 12′. Additionally, a surface layer 14′ is disposed on a radially outer surface side of the core metal 11.

Moreover, the terminal portion 21′ of Example 2 does not have the contact ring 22 and the connection flange 23 of the terminal portion 21 of Example 1, and the power-fed ring 24 is directly electrically connected to the heat generation layer 13′.

### Action of Example 2

In the heat generation roll 2′ of Example 2 including the above configuration, the heat generation layer 13′ is disposed inside the core metal 11, and the terminal portion 21′ does not require the contact ring 22 or the like. Therefore, it becomes easy to design and manufacture the outer diameter of the terminal portion 21′ to be equal to or smaller than the outer diameter of the surface layer 14′.

### Example 3

Next, Example 3 of the present invention will be described. In the description of Example 3, the constituent elements corresponding to the constituent elements of Example 1 are designated by the same reference numerals, and detailed description thereof will be omitted.

Example 3 is different from the above-mentioned Example 1 in the following points, but is configured similar to the above-mentioned Example 1 in other points.

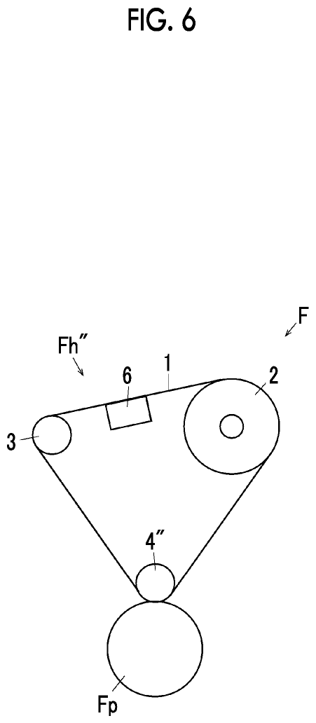

FIG. 6 is an explanatory view of a fixing device of Example 3.

In FIG. 6, in the heating unit Fh″ of Example 3, unlike the heating unit Fh of Example 1, a facing roll 4″ is used as an example of the facing section instead of the fixing pad 4. The facing roll 4″ is configured to be rotatable as the fixing belt 1 rotates.

### Action of Example 3

In the heating unit Fh″ of Example 3 including the above configuration, the facing roll 4″ is rotatable with the rotation of the fixing belt 1. Therefore, as compared to a case where a non-rotating fixing pad 4 is used, the wear of the fixing belt 1 and the facing roll 4″ is suppressed. Thus, the service life of the heating unit Fh″ is extended.

### Modification Examples

Although the Examples of the present invention have been described in detail above, the present invention is not limited to the above Examples, and various changes can be made within the scope of the gist of the present invention described in the claims. Examples of Modification Examples (H01) to (H010) of the present invention are illustrated below.

(H01) In the above Examples, the copying machine as an example of the image forming apparatus has been illustrated, but the present invention is not limited to this, and for example, the image forming apparatus can be configured by FAX, a printer, and a multifunction machine.

(H02) In the above Examples, a configuration in which the four-color developers are used has been exemplified as the image forming apparatus, but the present invention is not limited to this, and for example, can also be applied to a monochromatic image forming apparatus, and image forming apparatus of multiple colors of three colors or less, or five colors or more.

(H03) In the above Examples, a configuration in which the insulating layer 12 is directly disposed on the surface of the core metal 11 and the heat generation layer 13 is directly disposed on the surface of the insulating layer 12 has been exemplified, but the present invention is not limited to this. For example, as in a case where a primer layer coated with a primer for improving wettability and adhesiveness is provided between the insulating layer 12 and the heat generation layer 13, it is possible to adopt a configuration in which a separate layer is interposed between the insulating layer 12 and the heat generation layer 13.

(H04) In the above Examples, for example, it is desirable that the surface layer 14 is provided, but it is also possible to adopt a configuration in which the surface layer 14 is not provided.

(H05) In the above Examples, it is desirable that the surface layer 14 is made of, for example, an insulating material, but it is also possible to adopt a configuration in which the surface layer 14 is made of a conductive material.

(H06) In the above Examples, it is desirable that the surface layer 14 is made of, for example, a wear-resistant material, but it is also possible to adopt a configuration in which the surface layer 14 is made of, for example, a material that is easily worn with an emphasis on releasability.

(H07) In the above Examples, for example, it is desirable that a configuration having a low heat resistance is provided as the surface layer 14, but it is also possible to adopt a configuration having a high heat resistance.

(H08) In the above Examples, it is desirable that the axial lengths L1 to L4 of each part are configured, for example, as exemplified in the Examples, but can be appropriately changed depending on the design, specifications, and the like.

(H09) In the above Examples, a configuration in which the outer diameter of the terminal portion 21 is smaller than the outer diameter of the heat generation roll 2 has been exemplified, but the outer diameter of the terminal portion 21 and the outer diameter of the heat generation roll 2 can be identical.

(H010) In the above Examples, a configuration in which the lubricating material is supplied to the inner surface of the fixing belt 1 has been exemplified, but the present invention can also be applied to a configuration in which the lubricating material is not supplied.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
an endless belt-shaped section;
a heating section that supports and rotates the belt-shaped section and generates heat during energization to heat the belt-shaped section; and
a terminal portion that is provided at an end part of the heating section and feeds power to the heating section,
wherein an outer diameter of the terminal portion is equal to or smaller than an outer diameter of the heating section.

2. The fixing device according to claim 1,
wherein the outer diameter of the terminal portion is smaller than the outer diameter of the heating section.

3. The fixing device according to claim 2, further comprising:
a supply section that supplies a lubricating material to an inner surface of the belt-shaped section for lubricating between the belt-shaped section and the heating section.

4. The fixing device according to claim 1,
wherein a cylindrical heating section having a cylindrical base layer and a heat generation layer disposed on an inner surface side of the base layer, and
the terminal portion electrically connected to the heat generation layer are provided.

5. The fixing device according to claim 2,
wherein a cylindrical heating section having a cylindrical base layer and a heat generation layer disposed on an inner surface side of the base layer, and
the terminal portion electrically connected to the heat generation layer are provided.

6. The fixing device according to claim 3,
wherein a cylindrical heating section having a cylindrical base layer and a heat generation layer disposed on an inner surface side of the base layer, and
the terminal portion electrically connected to the heat generation layer are provided.

7. The fixing device according to claim 4,
wherein the terminal portion having a through-hole in an axial direction of the cylindrical heating section is provided.

8. The fixing device according to claim 5,
wherein the terminal portion having a through-hole in an axial direction of the cylindrical heating section is provided.

9. The fixing device according to claim 6,
wherein the terminal portion having a through-hole in an axial direction of the cylindrical heating section is provided.

10. The fixing device according to claim 1,
wherein a pressure section that transports a medium by sandwiching and pressurizing the medium between an outer surface of the belt-shaped section and the pressure section, and
a facing section that supports an inner surface of the belt-shaped section and is disposed to face the pressure section, and is non-rotating with respect to the rotating belt-shaped section are provided.

11. The fixing device according to claim 2,
wherein a pressure section that transports a medium by sandwiching and pressurizing the medium between an outer surface of the belt-shaped section and the pressure section, and
a facing section that supports an inner surface of the belt-shaped section and is disposed to face the pressure section, and is non-rotating with respect to the rotating belt-shaped section are provided.

12. The fixing device according to claim 3,
wherein a pressure section that transports a medium by sandwiching and pressurizing the medium between an outer surface of the belt-shaped section and the pressure section, and
a facing section that supports an inner surface of the belt-shaped section and is disposed to face the pressure section, and is non-rotating with respect to the rotating belt-shaped section are provided.

13. The fixing device according to claim 4,
wherein a pressure section that transports a medium by sandwiching and pressurizing the medium between an outer surface of the belt-shaped section and the pressure section, and
a facing section that supports an inner surface of the belt-shaped section and is disposed to face the pressure section, and is non-rotating with respect to the rotating belt-shaped section are provided.

14. The fixing device according to claim 5,
wherein a pressure section that transports a medium by sandwiching and pressurizing the medium between an outer surface of the belt-shaped section and the pressure section, and
a facing section that supports an inner surface of the belt-shaped section and is disposed to face the pressure section, and is non-rotating with respect to the rotating belt-shaped section are provided.

15. The fixing device according to claim 6,
wherein a pressure section that transports a medium by sandwiching and pressurizing the medium between an outer surface of the belt-shaped section and the pressure section, and
a facing section that supports an inner surface of the belt-shaped section and is disposed to face the pressure section, and is non-rotating with respect to the rotating belt-shaped section are provided.

16. The fixing device according to claim 7,
wherein a pressure section that transports a medium by sandwiching and pressurizing the medium between an outer surface of the belt-shaped section and the pressure section, and
a facing section that supports an inner surface of the belt-shaped section and is disposed to face the pressure section, and is non-rotating with respect to the rotating belt-shaped section are provided.

17. The fixing device according to claim 8,
wherein a pressure section that transports a medium by sandwiching and pressurizing the medium between an outer surface of the belt-shaped section and the pressure section, and
a facing section that supports an inner surface of the belt-shaped section and is disposed to face the pressure section, and is non-rotating with respect to the rotating belt-shaped section are provided.

18. The fixing device according to claim 9,
wherein a pressure section that transports a medium by sandwiching and pressurizing the medium between an outer surface of the belt-shaped section and the pressure section, and
a facing section that supports an inner surface of the belt-shaped section and is disposed to face the pressure section, and is non-rotating with respect to the rotating belt-shaped section are provided.

19. The fixing device according to claim 1,
wherein a pressure section that transports a medium by sandwiching and pressurizing the medium between an outer surface of the belt-shaped section and the pressure section, and
a facing section that supports an inner surface of the belt-shaped section and is disposed to face the pressure section and that rotates with the rotation of the belt-shaped section are provided.

20. An image forming apparatus comprising:
an image holding section;
a latent image forming section that forms a latent image on the image holding section;
a developing section that develops the latent image of the image holding section;
a transfer section that transfers an image of the image holding section to a medium; and
the fixing device according to claim 1 that fixes the image of the medium.
